(19) United States
(12) Patent Application Publication
(10) Pub. No.: US 2026/0143046 A1
(43) Pub. Date: May 21, 2026

(54) Message De-Duplication For Idempotent Message Delivery In Distributed Transactions

(71) Applicant: Oracle International Corporation, Redwood Shores, CA (US)

(72) Inventors: Todd J. Little, Lafayette, CA (US); Tushar Shaily, Bangalore (IN)

(21) Appl. No.: 18/953,604

(22) Filed: Nov. 20, 2024

(51) Int. Cl. H04L 67/60; H04L 41/50

(52) U.S. Cl. CPC H04L 67/60; H04L 41/50

(57) ABSTRACT

An interceptor on the sending side intercepts an outgoing service request and attaches a unique identifier header that must be presented with the request and with any retries of the request. An interceptor on the receiving side sees the unique identifier and queries a private data store to see if the request has been processed previously. If the request has not been seen before on the receiving side, the application processes the request as usual, and the receiving side interceptor captures the return payload along with the unique identifier. If the request has been seen before, then the receiving side interceptor simply returns the captured payload from the successful processing by the application.

### TECHNICAL FIELD

The present invention relates to performing transactions using services and, more particularly, to message de-duplication for idempotent message delivery for distributed transactions.

### BACKGROUND

Modern applications are built by composing a few services that are independently developed. A service is an architectural approach to software development that breaks large applications into smaller, independent services that communicate through application programming interfaces (APIs). Each service has its own responsibility and can communicate with other parts through simple interfaces. This provides agility and speed to market for fixing issues and introducing new features. This paradigm is often referred to as a microservices architecture, although the number of services that come together for a complete application can be in the hundreds (microservices), or in the tens (macroservices). As used herein, the term “service” may refer to a microservice or a macroservice. In a microservices architecture, each service owns a simple task and communicates with clients or other services using communication mechanisms such as representational state transfer (REST) APIs.

Each service may communicate with one or more resource managers to perform operations. A resource manager is a managed service that automates deployment and operations for a resource, such as a database. The services are typically developed and deployed independently, each with its own resource managers. When a business transaction spans multiple services, it is likely necessary that some mechanism be in place to ensure that updates in these services occur atomically, i.e., either all updates occur or none of them occur. A transaction manager simplifies application development and operations by enabling distributed transactions to ensure consistency across services and resource managers.

One issue in dealing with failures and recovery is how to properly handle duplicate requests, messages, or events. Many eventual consistency models require that services be idempotent, meaning they can be invoked multiple times but only one of the invocations succeeds. This is required to support retrying operations (e.g., transactions). Many messaging systems provide guarantees that messages will be delivered at least once, some provide guarantees that messages will be delivered at most once, and some claim to provide guarantees that messages will be delivered exactly once. It is believed that exactly-once message delivery cannot be achieved in practice. While it may not be possible to guarantee that a message will not be delivered more than once, it should be possible to guarantee that a message will not be processed more than once.

When implementing retry mechanisms in a distributed environment, it is likely that a request will be received more than once but should be processed only once. The issue comes from possible network communication failures that may result in a reply getting lost. In this case, the requestor must assume that the request was not received and, thus, resend the request. If the service blindly processes the retried request, it will likely incorrectly process the request multiple times.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram illustrating a microservices architecture in which aspects of the embodiments can be implemented.

FIG. 2 is a block diagram illustrating the use of interceptors in accordance with an embodiment.

FIG. 3 is a flowchart illustrating message de-duplication for idempotent message delivery in a microservices architecture in accordance with an embodiment.

FIG. 4 is a block diagram that illustrates a computer system upon which aspects of the illustrative embodiments may be implemented.

FIG. 5 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments attempt to achieve idempotent message delivery by implementing interceptors or filters to intercept outgoing requests and their responses as well as incoming requests and their responses. The filters (e.g., a client interceptor and server interceptor) work together to ensure a request is processed only once.

In accordance with an embodiment, an interceptor on the sending side intercepts an outgoing service request and attaches a unique identifier header that must be presented with the request and with any retries of the request. An interceptor on the receiving side sees the unique identifier and queries a private data store to see if the request has been processed previously. If the request has not been seen before on the receiving side, the application processes the request as usual, and the receiving side interceptor captures the return payload along with the unique identifier. If the request has been seen before, then the receiving side interceptor simply returns the captured payload from the successful processing by the application.

The embodiments make services idempotent with minimal to no code changes to applications. The work for tracking requests, retries, and return payloads is hidden in the interceptors. The embodiments simplify development of microservices-based applications and distributed transactions by ensuring idempotency without developers having to build idempotency and message de-duplication into application code.

### Microservices Architecture for Distributed Transactions

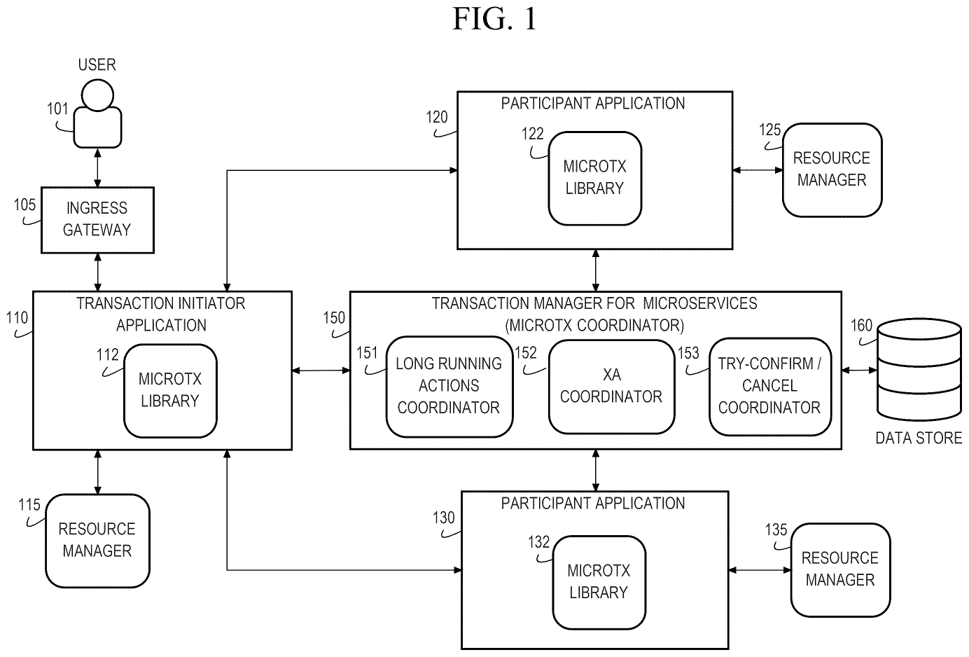

FIG. 1 is a block diagram illustrating a microservices architecture in which aspects of the embodiments can be implemented. In the depicted example, an application is built including a transaction initiator application 110, participant application 120, and participant application 130, which are services in the microservices architecture. User 101 calls transaction initiator application 110 using ingress gateway 105 to initiate a transaction. During execution of the transaction, transaction initiator application 110 can perform the transaction entirely using resources that are local to transaction initiator application 110 using one or more resource managers 115. Alternatively, transaction initiator application 110 can make a service call to participant application 120, participant application 130, or both. Participant application 120 and participant application 130 can also use resources using one or more resource managers 125, 135.

Transaction manager 150, also referred to as microservices transaction (MicroTx) coordinator, is a service that coordinates transactions that involve resource managers at multiple services, such as applications (services) 110, 120, 130, to ensure consistency and atomicity of transactions across services. Each service includes a transaction manager for microservices client library for communicating and coordinating with the transaction manager 150. Thus, transaction initiator application 110 includes MicroTx client library 112, participant application 120 includes MicroTx client library 122, and participant application 130 includes MicroTx client library 132. Transaction initiator application 110 enlists with the transaction manager 150 using the MicroTx client library 112 as a participant of the transaction.

Transaction manager 150 provides a set of REST services including long running actions coordinator 151, extended architecture (XA) coordinator 152, and try-confirm/cancel coordinator 153. Long running actions (LRA) coordinator 151 is a service that participant applications register with and is responsible for driving completion or compensation of a long running action. LRA transactions provide eventual consistency, and users may see inconsistent updates across resources for the duration of the distributed transaction. Development with LRAs can be more complex as users are required to write and test compensate business logic.

XA coordinator 152 provides an extended architecture (XA) transaction protocol for applications that require strong global consistency for distributed transactions. XA offers strong data consistency with low development complexity. XA transaction protocol eliminates the need for application specific business log to ensure consistency. Example implementations are described below with reference to the XA transaction protocol for ease of illustration; however, other implementations are within the spirit and scope of the embodiments described herein.

Try-confirm/cancel coordinator 153 uses a protocol that has an initiator ask other services to reserve resources or place them in escrow. Once the initiator 110 and all participant services 120, 130 have acquired the necessary reservations, the initiator 110 then asks transaction manager 150 to confirm all of the reservations. During the try phase, all accepted reservations are collected in headers by the MicroTx client library 112. This includes reservations made indirectly by services called by the initiator. By the time the initiator 110 has completed making reservations with service 120 and service 130, the MicroTx client library 112 has collected all the reservations in headers. At this point, in the confirm/cancel phase, the initiator can decide to confirm the reservations, cancel the reservations, or ignore the reservations by letting timeouts eventually cancel the reservations. Try-confirm/cancel coordinator 153 is used for services that need to place resources in reserve.

Transaction manager 150 uses data store 160 as a transaction log store to manage distributed transactions. When transaction initiator application 110 initiates a transaction, transaction manager 150 begins logging the transaction as a distributed transaction. Transaction initiator application 110 may perform operations using resource manager 111 as part of the distributed transaction. When transaction initiator application 110 calls participant application 120, participant application 120 may perform operations using resource manager 125 as a branch transaction that is part of the distributed transaction. Similarly, when transaction initiator application 110 calls participant application 130, participant application 130 may perform operations using resource manager 135 as a branch transaction that is part of the distributed transaction. To be atomic, the distributed transaction must successfully complete and commit all branch transactions. Transaction manager 150 uses data store 160 to log the distributed transaction and all branch transactions to ensure consistency.

### Interceptors for Request De-Duplication

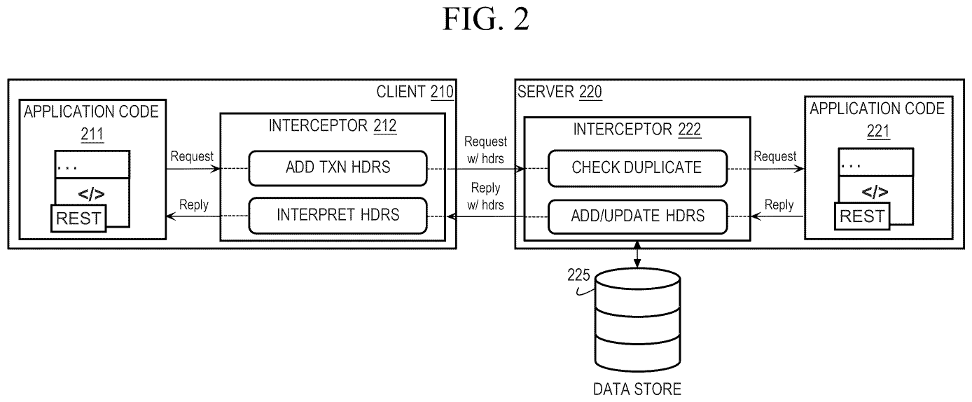

The embodiments use interceptors to simplify application development. FIG. 2 is a block diagram illustrating the use of interceptors in accordance with an embodiment. Application code 211 in client 210 communicates with application code 221 in server 220. In some embodiments, application code 211 comprises a REST client that sends a REST request to application code 221, which is also a REST application. While the applications are shown as REST applications, other transports can be used within the spirit and scope of the illustrative embodiments. Application code 221 processes the request and returns a reply. In an embodiment, client 210 is a client application, an initiator, or any participant service that calls another participant service, and server 220 is a service that is called by the client application, initiator, or another participant service. In an embodiment, a request may initiate a transaction, which may be local transaction, a distributed transaction, or a branch transaction that is part of a distributed transaction.

In client 210, interceptor 212 includes logic to intercept an outgoing REST request and add transaction headers to the REST request and logic to interpret transaction headers from a reply received from server 220. In an embodiment, interceptor 212 adds a unique identifier (ID) to a request and adds the same ID to retries of the request. Interceptor 212 forwards the request with the headers to server 220.

In server 220, interceptor 222 includes logic to intercept a REST request received from client 210 and check if the request is a duplicate based on a unique request identifier. Interceptor 222 also includes logic to intercept an outgoing reply and add or update transaction headers in the reply. Interceptors 212, 222 automatically propagate transaction context to other services and together handle de-duplication of messages. Note that the transaction ID cannot be used for the request ID, because the transaction ID remains the same for the entire length of a transaction, which may include more than one request. The interceptor must create a request ID that is unique to each request and remains the same for retries.

For a first instance of a message, interceptor 222 forwards the request to application code 221, which attempts to process the request. If application code 221 successfully processes the request, then application code 221 returns a reply to application code 211 in client 210. Interceptor 222 intercepts the reply, adds or updates the headers, and forwards the reply with the headers to client 210. In response to receiving a reply of successful processing of the request from application code 221, interceptor 222 also stores the reply in association with the request ID in data store 225.

As used herein, successfully processing a request refers to completing processing of the request and generating a reply. This may include processing in which business logic generates an error and including an error code in the reply. For example, if the request is for a transaction to withdraw an amount of money from an account, and the account does not have sufficient funds, then the application code can process the request with an error indicating insufficient funds. This is an example of successful processing of the request, even though the business logic of the application generated an error. In this instance, the client having received the reply is unlikely to retry the request based on the error, because a retry will also fail. Even if the client waited until the balance increases, such a request will have a different request ID and, thus, would not be considered a retry of the same request. The unique ID added by interceptor 212 distinguishes a retry of the same request from subsequent requests with the same payload.

In addition, there may be instances where it appears, from the perspective of interceptor 212, that application code 221 does not successfully process the request. For example, server 220 may return a reply with an error code that indicates application code 221 failed to process the request, as described above. As another example, a successful reply may be lost due to a communications failure. In this case, interceptor 212 may time out waiting for the reply. In these cases, interceptor 212 retries the request if the request is retriable (based on return codes) and retries are available. In one embodiment, a number of retries for a request (e.g., 3 retries) is a configurable parameter.

It is necessary to distinguish which return codes can or should cause a retry, as some things like expected application failures, e.g., account not found, make no sense to retry. An example of a request that is retriable is a request that failed due to a timeout. An example of a request that is not retriable is a request that received a reply with an error code that indicated a business logic error. If a request is not retriable or retries are not available for the request, then interceptor 212 sends a reply to application code 211 indicating failure.

In response to receiving a retry of a request, having the same request ID as the original request, interceptor 222 looks up the request ID in data store 225. If a reply is found in data store 225, then interceptor 222 replies success to client 210 with the stored reply. If a reply is not found in data store 225, then interceptor 222 forwards the request (i.e., the retry) to application code 221.

In some embodiments, the interceptors, such as interceptor 222, rely on application code 221 to store some state information in data store 225, such as what messages have already been successfully processed and return the previous result. In some embodiments, data store 225 is a database. If interceptor 222 can share the database connection the application code is using, then this may eliminate the need for any sort of distributed transaction. In one embodiment, an injected database connection is used, as is done with MicroTx client libraries, and that connection can be used by the interceptor, although connection injection is not required. In another embodiment, APIs the application needs to call can be used, giving the interceptor access to the application's database connection. Presumably auto-commit is turned off, when the application code returns to the interceptor, there will still be a pending local transaction that can be used to store the interceptor's state information (Unique ID and Success Payload), and then the updates of the application and the update of the interceptor can be committed atomically. Whatever mechanism is used to store information in the interceptors must be atomically updated with any application updates.

In one embodiment, data store 225 is a database, and application code 221 processes the request by performing operations on the database in a transaction. In this embodiment, interceptor 222 stored a result to the database in the same transaction as application code 221. The transaction may be a local transaction, which could be performed over a shared connection, or separate connections if the transaction can be shared. Alternatively, a distributed transaction can be used between the server side interceptor's data store 225 and the server application's data store (not shown). This allows for the server-side interceptor to potentially be in a separate process (e.g., a Kubernetes side car).

One embodiment defines interfaces and/or some abstract classes the application can use and provides concrete implementations. This can be as simple as the application providing a database connection with access to schema/tables that can be used. Alternatively, this can be abstracted further such that an in-memory database can be used, if desired.

In some embodiments, to address how long to keep the persisted information in data store 225, the interceptor uses something like sequence numbers. Then, the interceptor can determine that all previous sequence numbers have been processed. One embodiment provides a lazy deletion mechanism in interceptor 222 for the state information in the interceptor data store 225.

The interceptors must also address how to keep the interceptor's database state and the application persistent state in synch. If they are separate databases, then an XA transaction may be needed. Even if they are the same database, auto-commit can be disabled to allow application updates and interceptor updates to be grouped in a single transaction. The issue is that if the application state is updated and committed before the interceptor gets a chance to update its state to indicate the message was processed, then the whole process breaks down. This can be handled by setting auto-commit to false, which presumably would allow the interceptor to piggyback some DML to maintain its state.

Depending upon how the interceptor handles storing the results and return status, as mentioned above, one embodiment can use the transaction of the application, if the interceptor can be confident that the transaction is left open. It may be possible for the database to register callbacks, block the commit/rollback call, and to allow the interceptors to perform the commit/rollback calls.

In some embodiments, data store 225 is a relational database used to store the request status. In alternative embodiments, logging last resource (LLR) implementations, such as MongoDB, may be used. In some embodiments, the implementation must be configured on the server (callee) side, although parameters like timeout values, retry counts, backoff algorithm, etc., must be configured in the client (caller) side. Therefore, interceptor 212 may also have a data store (not shown). Some implications of this include:
1. The client (caller) will not know whether the service it is calling must be idempotent or not. The server (callee) makes that decision.
2. Consequently, if timeouts/retries are configured or enabled in the interceptors, they will retry whether the callee needs to be idempotent or not. If the server (callee) must be idempotent but does not enable the server-side interceptor, then the server will end up receiving duplicate messages, so care must be taken to ensure all idempotent callees use the client library.

### Procedural Overview

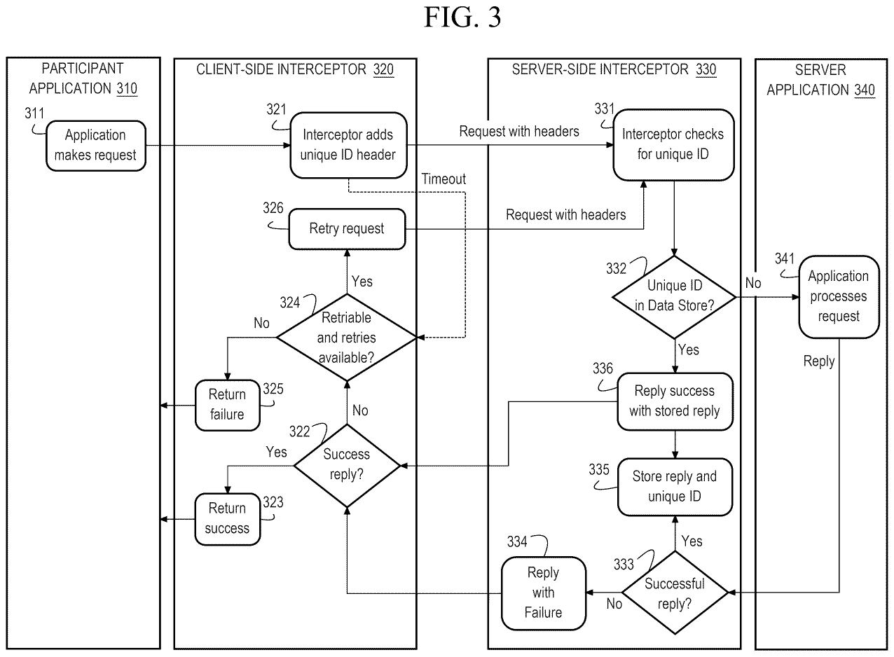

FIG. 3 is a flowchart illustrating message de-duplication for idempotent message delivery in a microservices architecture in accordance with an embodiment. Operation begins when participant (e.g., client) application 310 makes a request (block 311). Client-side interceptor 320 intercepts the request, adds a unique ID header, and forwards the request with headers to the server side (block 321).

Server-side interceptor 330 checks for the unique ID in a data store (e.g., a database) (block 331) and determines whether the unique ID is in the data store (block 332). If the unique ID is not in the data store (block 332: No), then server-side interceptor 330 forwards the request to server application 340. Then, server application 340 processes the request (block 341) and returns a reply.

Server-side interceptor 330 intercepts the reply and determines whether the reply indicates successful processing of the request (block 333). In one embodiment, server-side interceptor 330 determines whether a successful reply is received in response to determining that server application 340 successfully processed the request based on an error code in the reply, as described above. In one embodiment, server-side interceptor 330 determines that a successful reply is not received in response to a timeout prior to receiving a reply from server application 340; however, this may not be necessary, because the client-side interceptor will also time out and retry the request. If a successful reply is not received (block 333: No), then server-side interceptor 330 returns a reply with failure to the client side. If a successful reply is received (block 333: Yes), then server-side interceptor 330 stores the reply in association with the unique ID (block 335) and replies success with the stored reply to the client (block 336).

Client-side interceptor 320 intercepts the reply, whether it is a reply with success from block 336 or a reply with failure from block 334, and determines whether the reply is a success (block 322). If the reply is a success (block 322: Yes), then client-side interceptor 320 returns success to participant application 310 (block 323).

If the reply is not a success (block 322: No), then client-side interceptor 320 determines whether the request is retriable and retries are available (block 324). In some embodiments, client-side interceptor 320 determines whether a request is retriable based on error codes in the reply. Alternatively, if client-side interceptor times out without receiving a reply from the server, via server-side interceptor 330, then operation proceeds to block 324. If the request is not retriable or there are no retries available (block 324: No), then client-side interceptor 320 returns failure to participant application 310 (block 325). If the request is retriable and there are retries available (block 324: Yes), then client-side interceptor 320 retries the request (block 326) by resending the request with headers, which include the original unique ID, to the server.

Server-side interceptor 330 then intercepts the retry request and checks for the unique ID in the data store (block 331). If server-side interceptor 330 did not receive a reply from server application 340, then server-side interceptor 330 determines that the unique ID is not in the data store (block 332: No), and server-side interceptor 330 forwards the request to server application 340. Similarly, if server-side interceptor 330 did receive a reply from server application 340 that indicates that server application 340 was not able to process the request (based on error codes), then server-side interceptor 330 determines that the unique ID is not in the data store (block 332: No), and server-side interceptor 330 forwards the request to server application 340. Operation then proceeds as described above with respect to the initial request.

If server application 340 successfully processed the request in block 341 and server-side interceptor 330 stored the reply in block 335, then server-side interceptor 330 determines that the unique ID is in the data store (block 332: Yes) and replies success with the stored reply (block 336). Operation then proceeds to block 322, as described above.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

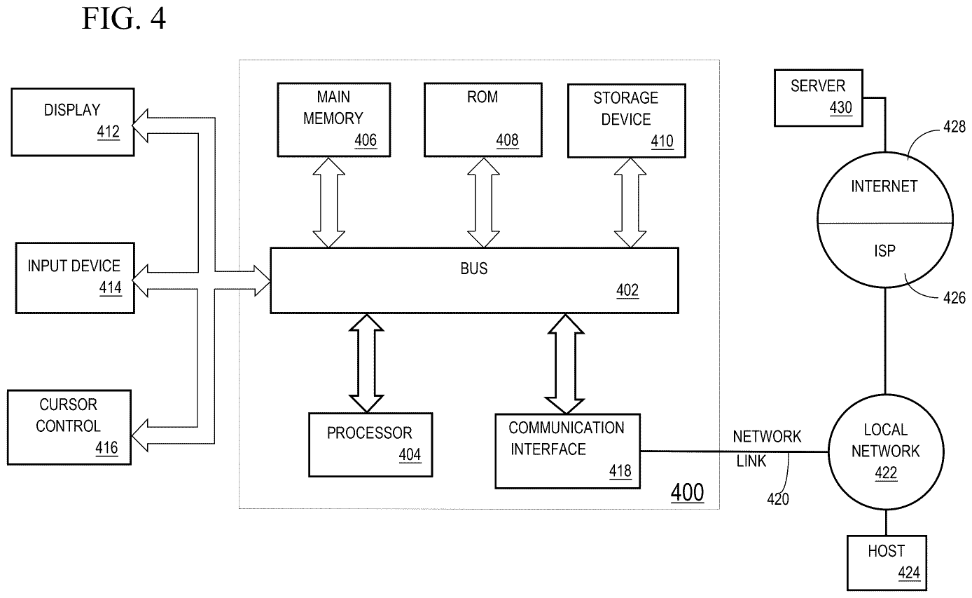

For example, FIG. 4 is a block diagram that illustrates a computer system 400 upon which aspects of the illustrative embodiments may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world-wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

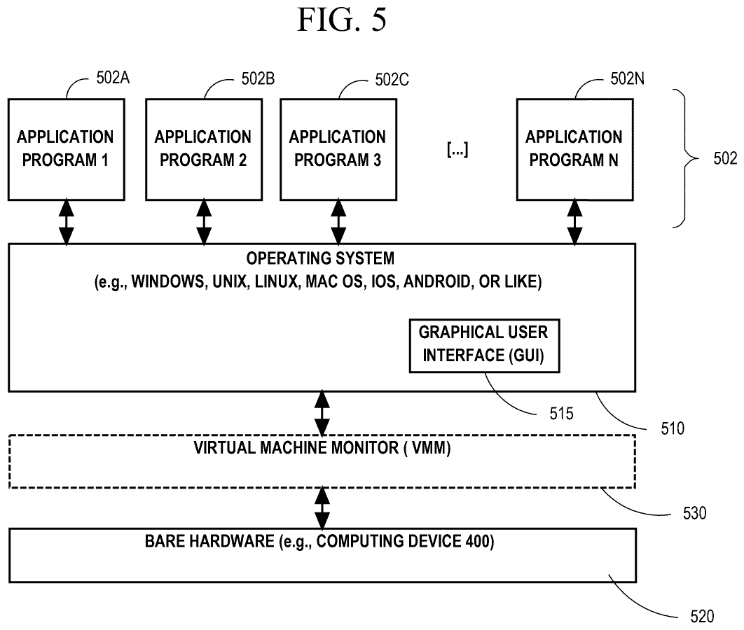

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include:
Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
handling, by a server-side interceptor, a request from a client to a server application,
wherein:
the request is associated with a request identifier,
handling the request comprises:
performing a lookup of the request identifier in a storage of replies from the server application;
in response to the lookup indicating an absence of the request identifier in the storage of replies from the server application, sending the request to the server application,
wherein the method is performed by one or more computing devices.

2. The method of claim 1, wherein handling the request further comprises:
in response to receiving a successful reply from the server application for the request, storing the successful reply in association with the request identifier and returning the successful reply to the client.

3. The method of claim 2, wherein the successful reply includes an error code indicating a business logic failure during processing of the request.

4. The method of claim 2, further comprising:
handling, by the server-side interceptor, a subsequent request from the client, wherein:
the subsequent request is a retry request associated with the request identifier,
handling the subsequent request comprises:
performing a subsequent lookup of the request identifier in the storage of replies from the server application;
in response to the subsequent lookup indicating presence of the request identifier in the storage of replies from the server application, sending the successful reply to the client.

5. The method of claim 1, wherein handling the request further comprises:
in response to receiving a reply with failure from the server application for the request, returning the reply with failure to the client.

6. The method of claim 5, wherein the reply with failure comprises an error code indicating failure by the server application to process the request.

7. The method of claim 1, wherein:
the storage of replies comprises a database,
the request is part of a transaction, and
storage of the replies to the database is part of the transaction.

8. A method comprising:
handling, by a client-side interceptor, a request from a client application to a server application, comprising:
adding a request identifier to a header of the request;
sending the request to the server application;
in response to a failure condition, generating a retry request having the request identifier added to a header of the retry request and sending the retry request to the server,
wherein the method is performed by one or more computing devices.

9. The method of claim 8, wherein the failure condition comprises a timeout expiring without receiving a reply from the server application.

10. The method of claim 8, wherein:
handling the request further comprises:
receiving a reply with failure from the server application; and
determining whether the request is retriable based on an error code of the reply, the failure condition comprises a determination that the request is not retriable.

11. The method of claim 10, wherein determining whether the request is retriable comprises determining whether a predetermined number of retries have been attempted for the request.

12. The method of claim 8, wherein the failure condition comprises the reply including an error code that indicates the request was not successfully processed.

13. One or more non-transitory computer-readable media storing instructions which, when executed by one or more processors, cause:
handling, by a server-side interceptor, a request from a client to a server application, wherein:
the request is associated with a request identifier,
handling the request comprises:
performing a lookup of the request identifier in a storage of replies from the server application;
in response to the lookup indicating an absence of the request identifier in the storage of replies from the server application, sending the request to the server application.

14. The one or more non-transitory computer-readable media of claim 13, wherein handling the request further comprises:
in response to receiving a successful reply from the server application for the request, storing the successful reply in association with the request identifier and returning the successful reply to the client.

15. The one or more non-transitory computer-readable media of claim 14, wherein the successful reply includes an error code indicating a business logic failure during processing of the request.

16. The one or more non-transitory computer-readable media of claim 14, further comprising:
handling, by the server-side interceptor, a subsequent request from the client, wherein:
the subsequent request is a retry request associated with the request identifier,
handling the subsequent request comprises:
performing a subsequent lookup of the request identifier in the storage of replies from the server application;
in response to the subsequent lookup indicating presence of the request identifier in the storage of replies from the server application, sending the successful reply to the client.

17. The one or more non-transitory computer-readable media of claim 13, wherein handling the request further comprises:
in response to receiving a reply with failure from the server application for the request, returning the reply with failure to the client.

18. The one or more non-transitory computer-readable media of claim 17, wherein the reply with failure comprises an error code indicating failure by the server application to process the request.

19. The one or more non-transitory computer-readable media of claim 13, wherein:
the storage of replies comprises a database,
the request is part of a transaction, and
storage of the replies to the database is part of the transaction.

20. One or more non-transitory computer-readable media storing instructions which, when executed by one or more processors, cause:
handling, by a client-side interceptor, a request from a client application to a server application, comprising:
adding a request identifier to a header of the request;
sending the request to the server application;
in response to a failure condition, generating a retry request having the request identifier added to a header of the retry request and sending the retry request to the server.
